(19) United States
(12) Patent Application Publication
(10) Pub. No.: US 2017/0182721 A1
(43) Pub. Date: Jun. 29, 2017

(54) METHOD AND DEVICE FOR FORMING A COMPOSITE PIPE

(71) Applicant: Ching-Long ONG, TAICHUNG CITY (TW)

(72) Inventor: Ching-Long ONG, TAICHUNG CITY (TW)

(21) Appl. No.: 15/375,867

(22) Filed: Dec. 12, 2016

(30) Foreign Application Priority Data
Dec. 25, 2015 (TW) 104143686

(51) Int. Cl. B29C 70/78; B29C 70/44

(52) U.S. Cl. CPC B29C 70/78; B29C 70/446; B29K 2705/00

(57) ABSTRACT

A method and a device are capable of forming a composite pipe with strengthened structure and improved solidification, wherein the method includes a step of mold closing, a step of mold placing, a step of enclosing with vacuum bagging film, a step of vacuuming, a step of pressuring, a step of heating, a step of vacuum bagging film removal, and a step of mold opening. The formed composite pipe has a strengthened structure and is improved in solidification effect.

### BACKGROUND OF THE INVENTION

Field of the Invention

The present invention relates to a device for forming a pipe, and more particularly to a device and a method for forming a composite pipe.

Related Prior Art

Metal pipes sold on the market have wide applications in many fields, among them, among them, long metal pipes are mainly used for transportation of gas or liquid. Metal is very hard and therefore can stand relatively large pressure. However, metal pipes are heavier and more expensive than pipes made of other materials. There are also some basic pipe structures, wherein the pipe is very short and has complicated inner surface to meet the requirements of different projects. For example, the pipe is provided with the hollow disc-shaped structure or wheel-shaped outer frame in order to deal with the stresses in different directions. Therefore, a composite pipe made of metal and composite material was invented by the industry, which has the advantage of low cost, and the strength and hardness of the composite pipe are also not inferior to the metal pipes.

A conventional device for forming the composite pipe is shown in FIG. 1, and comprises: a first mold 91 and a second mold 92. Each of the first and second molds 91, 92 is provided around the outer periphery with a concave portion U. The first and second molds 91, 92 are connected together, so that the concave portion U of the first mold 91 in communication with the concave portion U of the second mold 92 to form a groove U1.

The method for forming a composite pipe with the abovementioned device includes the following steps:
First, laying a base material K and at least one pre-impregnated composite layer L in the mold, the pre-impregnated composite layer L includes a layer of fibers L1 and a layer of resin L2;
heating the groove U1, so that the base material K and the pre-impregnated composite layer L laid in the groove U1 are heated, and the layer of resin L2 is also heated to glue the pre-impregnated composite layer L and the base material K together into a composite pipe;
opening the first and second molds 91, 92 and taking out the composite pipe.

However, the formed composite pipe has the following disadvantages: uneven distribution of material and nonuniform thickness, which is likely to cause uneven stressing, and uneven heating during the heating process. As a result, the bonding between the base material and the composite material is substantially reduced, which will affect the structural stability of the composite pipe. Hence, a method and device for forming a composite pipe is necessary.

### SUMMARY

An objective of the present invention is to provide a method for forming a composite pipe with strengthened structure and improved solidification.

Another objective of the present invention is to provide a device for being used in combination with the method to manufacturing the composite pipe.

To achieve the above objects, a device for forming a composite pipe in accordance with the present invention comprises:
a first mold provided around an outer periphery thereof with a first mold surface, and further including a first connecting end and an opposite first restricting end which has a diameter larger than a diameter of the first connecting end;
a second mold provided around an outer periphery thereof with a second mold surface and further including a second connecting end and an opposite second restricting end which has a diameter larger than a diameter of the second connecting end, wherein the second connecting end is connected to the first connecting end, and the first mold surface is connected to the second mold surface to form a molding surface; and
a vacuum bagging film enclosing the first and second molds to form an airtight space between the vacuum bagging film and the first and second molds, wherein the vacuum bagging film is connected to a vacuum pump which is in communication with the airtight space.

A method for forming the composite pipe by using the device as mentioned above, comprises the following steps:
a step of mold closing, including: providing a base material, the first mold and the second mold, wherein the base material is tube-shaped and includes a penetrating hole which includes a first open end and an opposite second open end; moving the first and second molds from the first and second open ends, respectively, toward the base material, wherein the first mold is inserted from the first open end into the penetrating hole of the base material, and the second mold is inserted from the second open end into the penetrating hole of the base material; connecting the first connecting end of the first mold to the second connecting end of the second mold, so that the first and second mold surfaces are connected to form the molding surface, and the base material covers the molding surface;
a step of mold placing, including: laying at least one composite and at least one metal alternatively on the base material, wherein the composite includes a resin and fibers;
a step of enclosing with vacuum bagging film, including enclosing the first and second molds with the vacuum bagging film, to form the airtight space between the vacuum bagging film and the first and second molds;
a step of vacuuming including: vacuuming the airtight space with the vacuum pump, and creating air difference between the inside and outside of the airtight space to force the vacuum bagging film to press against the composite and the metal, so that the base material, the composite and the metal are pressed against one another, and bonded together by the resin to form the composite pipe;
a step of vacuum bagging film removal including: removing the vacuum bagging film from the first and second molds; and
a step of mold opening including: separating the first and second molds from each other to demold the composite pipe, so as to facilitate a user to take out the composite pipe.

With the step of mold closing, the step of mold placing, the step of enclosing with vacuum bagging film, the step of vacuuming, the step of pressuring, the step of heating, the step of vacuum bagging film removal, and the step of mold opening, the method in accordance with the present invention is capable of manufacturing a composite pipe with strengthened structure and improved solidification. Besides, the present invention can also be used in combination with the rotary table which is equipped with the power source to facilitate introduction of the pipe onto the platform of the autoclave, so that, in the step of heating, centrifugal force can be generated by rotation to ensure even distribution of the resins of the composite on the outer peripheral surface of the pipe, which could produce better surface quality.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 shows the conventional device for forming the composite pipe;

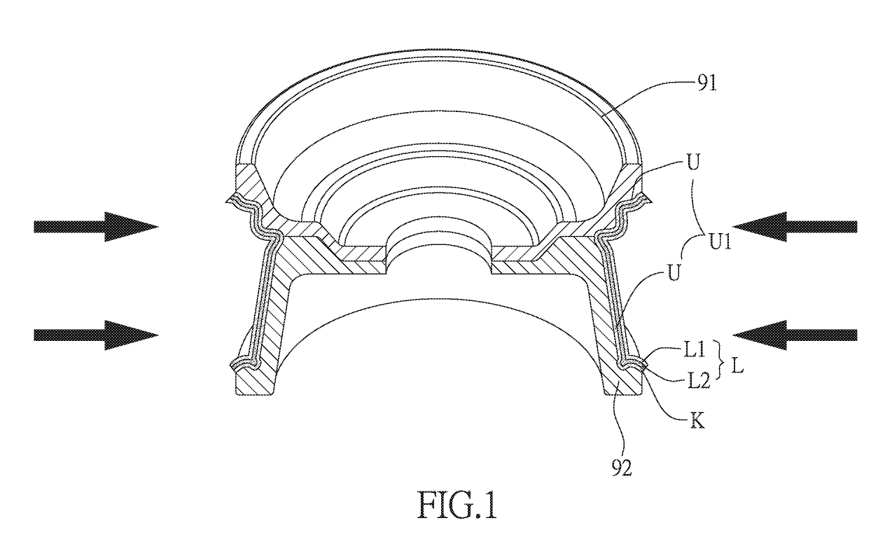

FIG. 2 shows a device for forming a composite pipe in accordance with a preferred embodiment of the present invention;

FIG. 3A is an illustrative view showing the mold closing step of the method for forming the composite pipe in accordance with the preferred embodiment of the present invention;

FIG. 3B is another illustrative view showing the mold closing step of the method for forming the composite pipe in accordance with the preferred embodiment of the present invention;

FIG. 4 is an illustrative view showing the steps of molding placing and enclosing with vacuum bagging film of the method for forming the composite pipe in accordance with the preferred embodiment of the present invention;

FIG. 5 is an illustrative view showing the step of vacuuming of the method for forming the composite pipe in accordance with the preferred embodiment of the present invention;

FIG. 6 is an illustrative view showing the steps of pressuring and heating of the method for forming the composite pipe in accordance with the preferred embodiment of the present invention;

FIG. 7 is an illustrative view in accordance with the preferred embodiment of the present invention, showing that the pipe is used combination with the rotary table with the power source;

FIG. 8 is an illustrative view showing the step of molding opening of the method for forming the composite pipe in accordance with the preferred embodiment of the present invention; and

FIG. 9 is a flow chart showing the steps of the method for forming the composite pipe in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

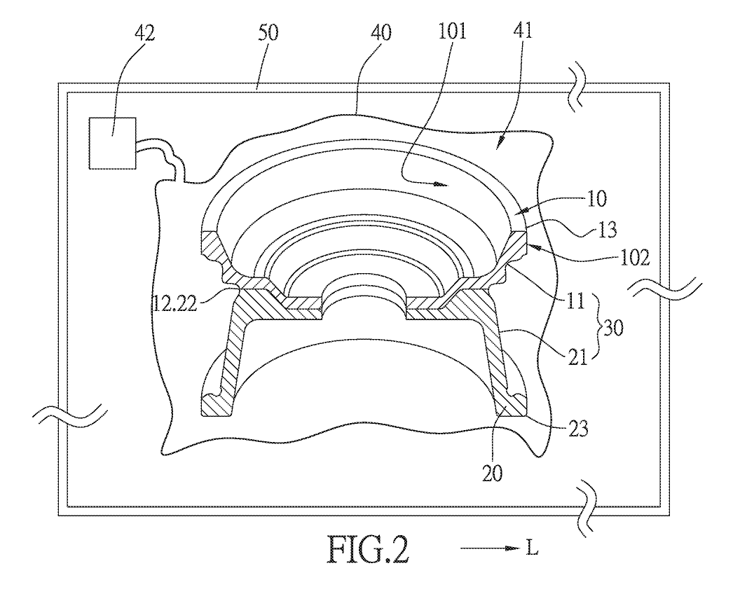

Referring to FIG. 2, a device for forming a composite pipe in accordance with the preferred embodiment of the present invention comprises: a first mold 10, a second mold 20, a vacuum bagging film 40, and an autoclave 50.

The first mold 10 is provided around an outer periphery thereof with a first mold surface 11, and further includes a first connecting end 12 and an opposite first restricting end 13 which has a diameter larger than a diameter of the first connecting end 12. The first mold 10 includes a first inner surface 101 and an opposite first outer surface 102. The first mold surface 11 is located on the first outer surface 102. A direction extending from the first inner surface 101 to the first outer surface 102 is defined as an expanding direction L, and the first mold surface 11 expands in the expanding direction L from the first connecting end 12 to the first restricting end 13.

The second mold 20 is provided around an outer periphery thereof with a second mold surface 21 and further includes a second connecting end 22 and an opposite second restricting end 23 which has a diameter larger than a diameter of the second connecting end 22. The second connecting end 22 is connected to the first connecting end 12. The first mold surface 11 is connected to the second mold surface 21 to form a molding surface 30. The second mold surface 21 expands in the expanding direction L from the second connecting end 22 to the second restricting end 23.

The vacuum bagging film 40 encloses the first and second molds 10, 20 to form an airtight space 41 between the vacuum bagging film 40 and the first and second molds 10, 20. The vacuum bagging film 40 isolates the airtight space 41 from external air, and is connected to a vacuum pump 42 which is in communication with the airtight space 41.

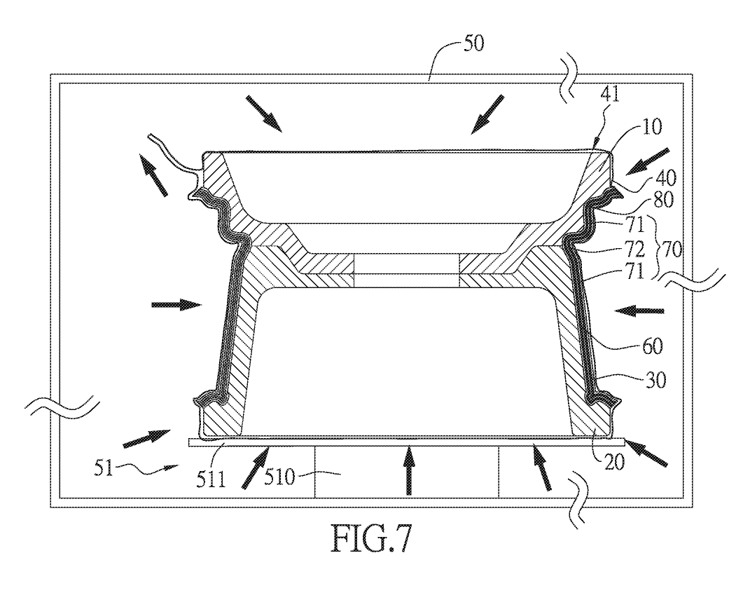

The first and second molds 10, 20 and the vacuum bagging film 40 are disposed in the autoclave 50 which is used to heat the first and second molds 10, 20 and the vacuum bagging film 40. Or as shown in FIG. 7, the autoclave 50 can be used in combination with a rotary table 51 which is equipped with a power source 510. A platform 511 is provided on the top of the power source 510, so that pipes can be placed on the platform 511 of the autoclave 50.

A method for forming a composite pipe in accordance with the present invention comprises the following steps:

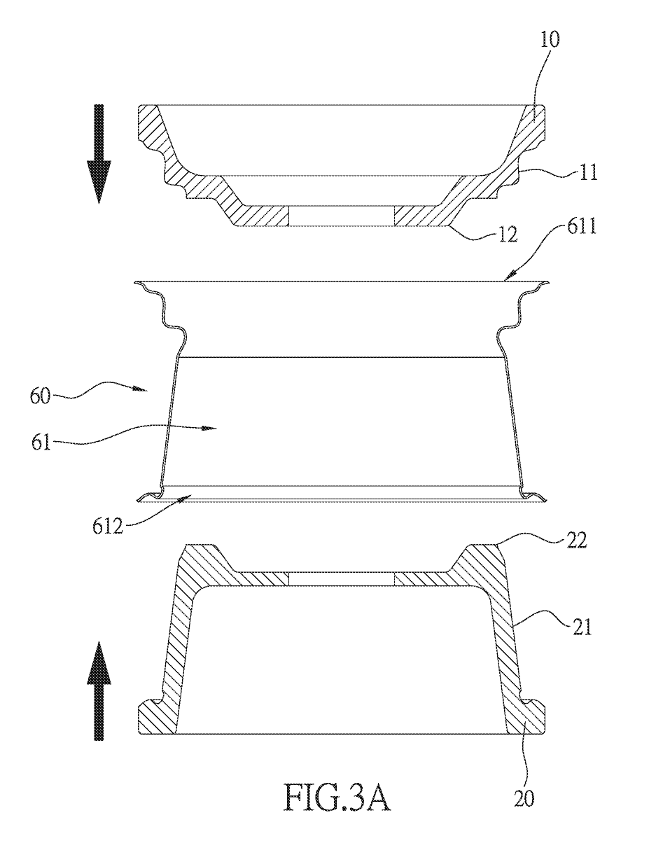

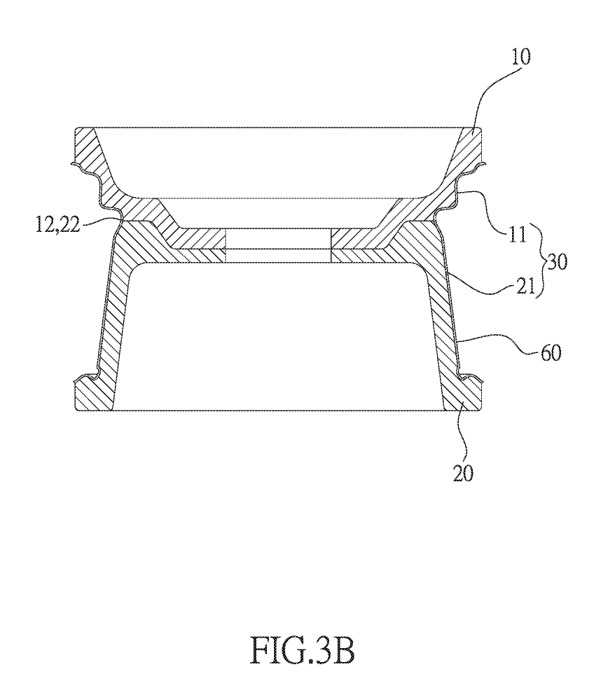

A step A of mold closing, as shown in FIGS. 3A to 9, includes: providing a base material 60, the first mold 10 and the second mold 20, wherein the base material 60 is tube-shaped and includes a penetrating hole 61 which includes a first open end 611 and an opposite second open end 612; moving the first and second molds 10, 20 from the first and second open ends 611, 612, respectively, toward the base material 60, wherein the first mold 10 is inserted from the first open end 611 into the penetrating hole 61 of the base material 60, and the second mold 20 is inserted from the second open end 612 into the penetrating hole 61 of the base material 60; connecting the first connecting end 12 of the first mold 10 to the second connecting end 22 of the second mold 20, so that the first and second mold surfaces 11, 12 are connected to form the molding surface 30, and the base material 60 covers the molding surface 30;

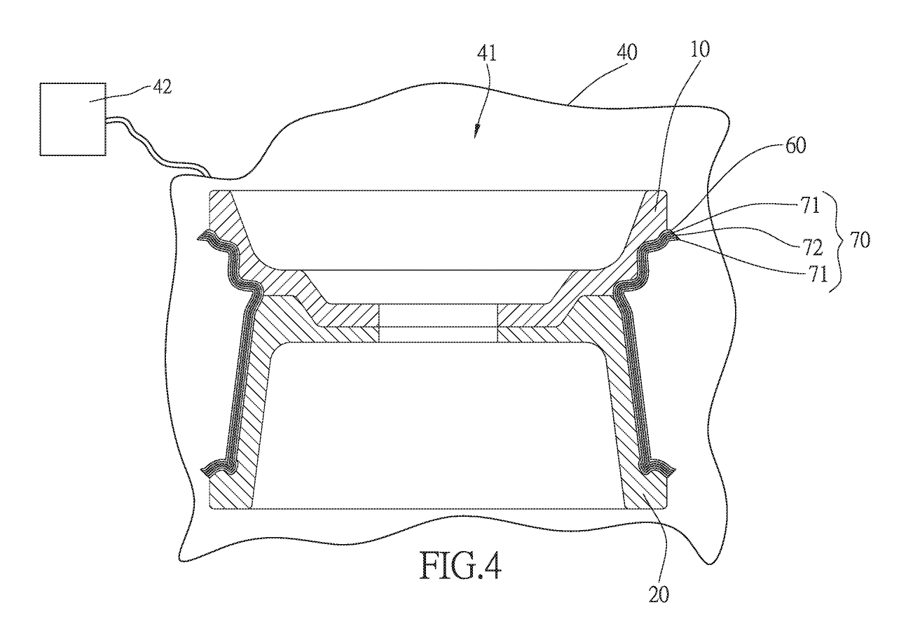

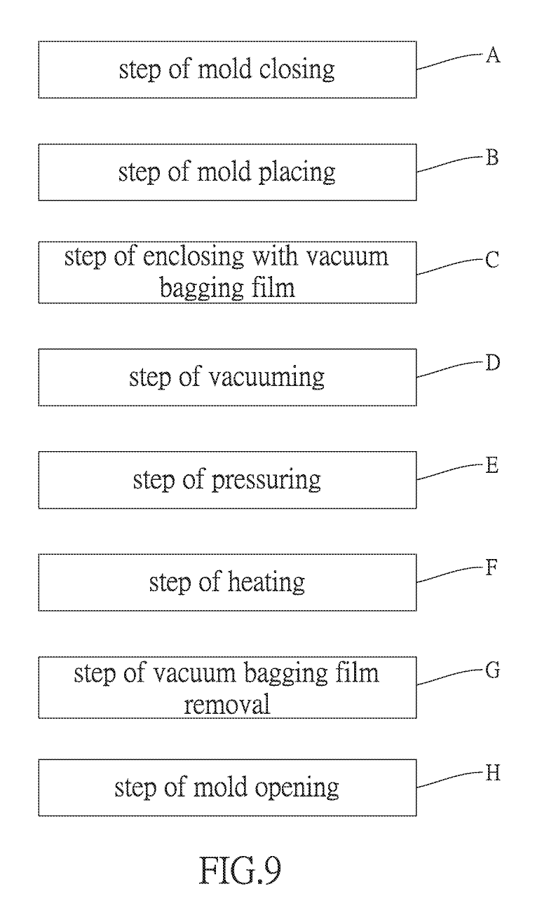

A step B of mold placing, as shown in FIGS. 4 and 9, includes: laying at least one composite 70 and at least one metal 80 alternatively on the base material 60. The material of the composite 70 is determined by product application, and can be carbon fiber composite material, Clarke fiber composite material, glass fiber composite, dyed fiber composite material or mixed fiber composite material. The composite 70 includes a resin 71 and fibers 72. The resin 71 is a thermosetting resin. The weaving method of the fibers 72 is selected from the group consisting of parallel arrangement, plain weave, satin weave, twill weave and multiaxial weave;

A step C of enclosing with vacuum bagging film, as shown in FIGS. 4 and 9, includes: enclosing the first and second molds 10, 20 with the vacuum bagging film 40, to form the airtight space 41 between the vacuum bagging film 40 and the first and second molds 10, 20.

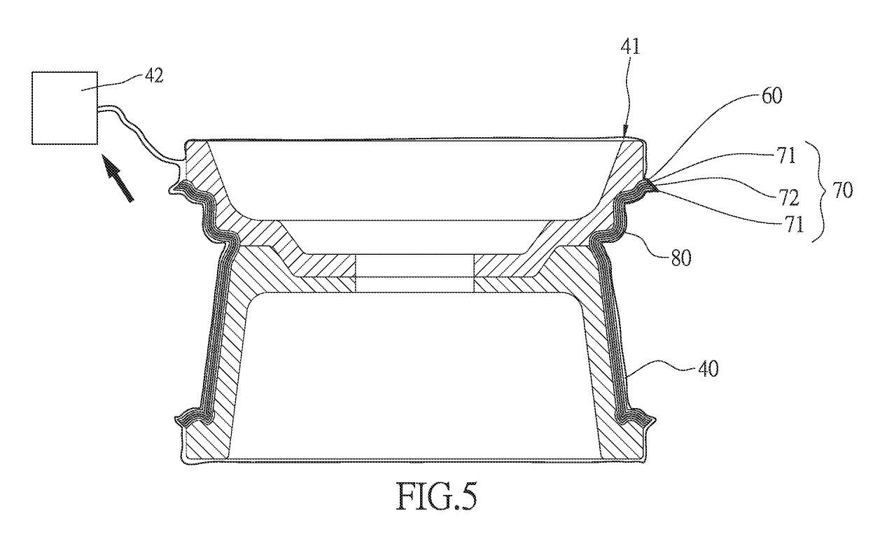

A step D of vacuuming, as shown in FIGS. 5 and 9, includes: vacuuming the airtight space 41 with the vacuum pump 42, and creating air difference between the inside and outside of the airtight space 41 to force the vacuum bagging film 40 to press against the composite 70 and the metal 80, so that the base material 60, the composite 70 and the metal 80 are pressed tightly against one another, and bonded together by the resin 71 to form a composite pipe;

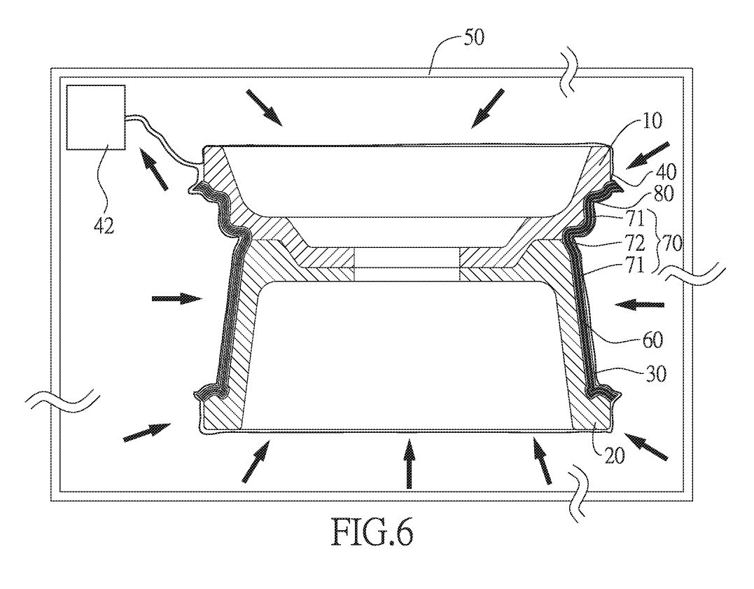

A step E of pressuring, as shown in FIGS. 6 and 9, includes: placing the first mold 10, the second mold 20 and the vacuum bagging film 40 into the autoclave 50, and pressuring the first mold 10, the second mold 20 and the vacuum bagging film 40 with the autoclave 50, so as to increase the pressing force of the vacuum bagging film 40 applied to the composite 70 and the metal 80, and enhance the bonding stability of the base material 60, the composite 70 and the metal 80;

A step F of heating, as shown in FIGS. 6 and 9, includes: heating the base material 60, the composite 70 and the metal 80 with the autoclave 50 to enhance the solidification of the base material 60, the composite 70 and the metal 80;

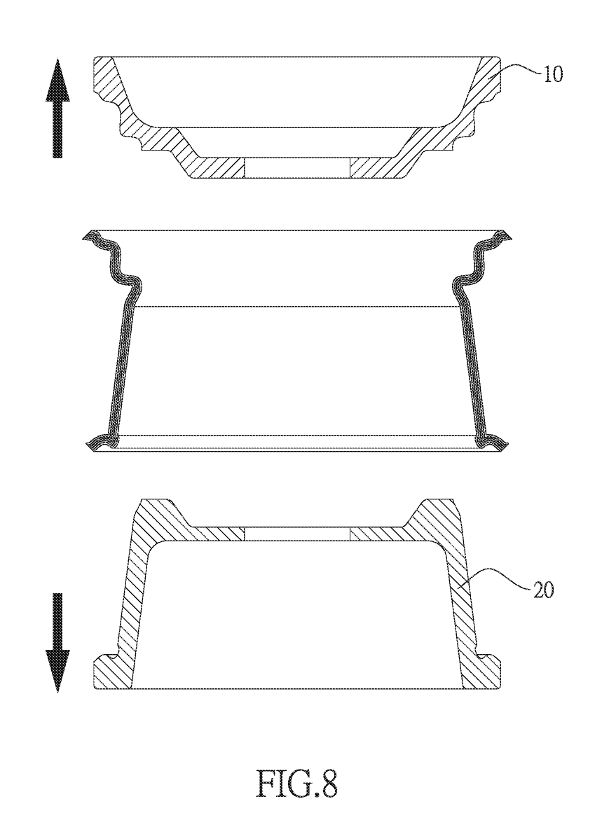

A step G of vacuum bagging film removal, as shown in FIG. 8, includes: removing the vacuum bagging film 40 from the first and second molds 10, 20; and

A step H of mold opening, as shown in FIGS. 8 and 9, includes: separating the first and second molds 10, 20 from each other to demold the composite pipe, so as to facilitate a user to take out the composite pipe.

With the step A of mold closing, the step B of mold placing, the step C of enclosing with vacuum bagging film, the step D of vacuuming, the step E of pressuring, the step F of heating, the step G of vacuum bagging film removal, and the step H of mold opening, the method in accordance with the present invention is capable of manufacturing a composite pipe with strengthened structure and improved solidification. Besides, the present invention can also be used in combination with the rotary table 51 which is equipped with the power source 510 to facilitate introduction of the pipe onto the platform 511 of the autoclave 50, so that, in the step F of heating, centrifugal force can be generated by rotation to ensure even distribution of the resins of the composite on the outer peripheral surface of the pipe, which could produce better surface quality.

While we have shown and described various embodiments in accordance with the present invention, it is clear to those skilled in the art that further embodiments may be made without departing from the scope of the present invention.

What is claimed is:

1. A device for forming a composite pipe comprising:
a first mold provided around an outer periphery thereof with a first mold surface, and further including a first connecting end and an opposite first restricting end which has a diameter larger than a diameter of the first connecting end;
a second mold provided around an outer periphery thereof with a second mold surface and further including a second connecting end and an opposite second restricting end which has a diameter larger than a diameter of the second connecting end, wherein the second connecting end is connected to the first connecting end, and the first mold surface is connected to the second mold surface to form a molding surface; and
a vacuum bagging film enclosing the first and second molds to form an airtight space between the vacuum bagging film and the first and second molds, wherein the vacuum bagging film is connected to a vacuum pump which is in communication with the airtight space.

2. The device for forming the composite pipe as claimed in claim 1 further comprising an autoclave, and the first mold, the second mold and the vacuum bagging film are disposed in the autoclave.

3. The device for forming the composite pipe as claimed in claim 1, wherein the first mold includes a first inner surface and an opposite first outer surface, the first mold surface is located on the first outer surface, a direction extending from the first inner surface to the first outer surface is defined as an expanding direction, and the first mold surface expands in the expanding direction from the first connecting end to the first restricting end.

4. The device for forming the composite pipe as claimed in claim 1, wherein a rotary table which is equipped with a power source is disposed in the autoclave, and a platform is provided on a top of the power source, so that pipes are allowed to be placed on the platform of the autoclave.

5. A method for forming the composite pipe by using the device as claimed in claim 1, comprising the following steps:
a step of mold closing, including: providing a base material, the first mold and the second mold, wherein the base material is tube-shaped and includes a penetrating hole which includes a first open end and an opposite second open end;
moving the first and second molds from the first and second open ends, respectively, toward the base material, wherein the first mold is inserted from the first open end into the penetrating hole of the base material, and the second mold is inserted from the second open end into the penetrating hole of the base material; connecting the first connecting end of the first mold to the second connecting end of the second mold, so that the first and second mold surfaces are connected to form the molding surface, and the base material covers the molding surface;
a step of mold placing, including: laying at least one composite and at least one metal alternatively on the base material, wherein the composite includes a resin and fibers;
a step of enclosing with vacuum bagging film, including enclosing the first and second molds with the vacuum bagging film, to form the airtight space between the vacuum bagging film and the first and second molds;
a step of vacuuming including: vacuuming the airtight space with the vacuum pump, and creating air difference between the inside and outside of the airtight space to force the vacuum bagging film to press against the composite and the metal, so that the base material, the composite and the metal are pressed against one another, and bonded together by the resin to form the composite pipe;
a step of vacuum bagging film removal including: removing the vacuum bagging film from the first and second molds; and
a step of mold opening including: separating the first and second molds from each other to demold the composite pipe, so as to facilitate a user to take out the composite pipe.

6. The method as claimed in claim 5 further comprising a step of pressuring after the step of vacuuming, and the pressuring step includes: placing the first mold, the second mold and the vacuum bagging film into the autoclave, and pressuring the first mold, the second mold and the vacuum bagging film with the autoclave, so as to increase pressing force of the vacuum bagging film applied to the composite and the metal, and enhance bonding of the base material, the composite and the metal.

7. The method as claimed in claim 5 further comprising a step of heating the base material, the composite and the metal with the autoclave to enhance solidification effect of the base material, the composite and the metal.

8. The method as claimed in claim 6 further comprising a step of heating the base material, the composite and the metal with the autoclave to enhance solidification effect of the base material, the composite and the metal.

9. The method as claimed in claim 5, wherein the material of the composite is selected from a group consisting of fiber composite material, Clarke fiber composite material, glass fiber composite, dyed fiber composite material and mixed fiber composite material, and the weaving method of the fibers is selected from the group consisting of parallel arrangement, plain weave, satin weave, twill weave and multiaxial weave.
